(19) United States
(12) Patent Application Publication
(10) Pub. No.: US 2023/0012392 A1
(43) Pub. Date: Jan. 12, 2023

(54) Exterior Microphone Camera System

(71) Applicant: Panasonic Automotive Systems Company of America, Division of Panasonic Corporation of North America, Peachtree City, GA (US)

(72) Inventor: KEITH RONALD WRISLEY, FENTON, MI (US)

(21) Appl. No.: 17/695,880

(22) Filed: Mar. 16, 2022

Related U.S. Application Data
(60) Provisional application No. 63/220,658, filed on Jul. 12, 2021.

(51) Int. Cl. B60R 11/04; H04N 5/225; H04B 1/04

(52) U.S. Cl. CPC B60R 11/04; H04N 5/2252; H04B 1/04; B60R 2011/004

(57) ABSTRACT

A motor vehicle includes a microphone detecting sounds originating outside of the motor vehicle. The microphone is disposed within a housing. A camera captures images of a scene outside of the motor vehicle. The camera is also disposed within the housing. Signals dependent upon the sounds detected by the microphone and signals dependent upon images captured by the camera are carried by a same communication channel.

### CROSS-REFERENCED TO RELATED APPLICATIONS

This application claims benefit of U.S. Provisional Application No. 63/220,658, filed on Jul. 12, 2021, the disclosure of which is hereby incorporated by reference in its entirety for all purposes.

### BACKGROUND OF THE INVENTION

### 1. Field of the Invention

The present invention relates to an external microphone system in a motor vehicle.

### 2. Description of the Related Art

Autonomous vehicles, or other vehicles relying on sensor inputs to calculate safe vehicle transit, must correctly determine the presence of emergency vehicle sirens. One approach to receiving sensor information is to mount a microphone (e.g., acoustic transducer) externally to a vehicle. It is known for such external microphones to experience and/or cause unwanted radio frequency interference.

One alternative to an external microphone is to place a microphone inside the vehicle. Due to the isolation of sheet metal and glass, routine road noise, environmental control fan noise and a variety of other noises, an internal microphone is much less effective at detecting sirens than an external microphone. Signal processing can be done to moderate these issues; however, it increases software complexity.

Some current vehicles utilize non-integrated microphones, wiring and control electronics, which adds cost, weight, and packaging issues. A discrete stand-alone system with dedicated hardware/software includes separate microphone/s, mounting brackets, dedicated wiring harness, and dedicated control electronics. This complexity can also require additional component validation testing.

The need for exterior vehicle microphones is growing as voice commands are being implemented for improved end user experience. Adding exterior microphones to a vehicle currently requires occupation of additional packaging space by the new assembly and requires additional wiring and control electronics for processing audio and vehicle bus messaging.

### SUMMARY OF THE INVENTION

The present invention provides an exterior microphone integrated within the assembly of a vehicle's exterior camera(s). The exterior camera may include the microphone(s) and supporting electronics inside one assembly. The serial camera interface (FPD-Link3, APIX, GMSL, etc.) may be used to transmit video signals from the camera to the in-vehicle infotainment (IVI) system. The camera serial interface may also be used to transmit audio signals to the IVI system via a serial data back channel and additionally accommodate bi-directional control signals to and from the Camera/Microphone assembly and the IVI system. Architecture in the vehicle may wake up the vehicle bus, which in turn allows the IVI system to wake up and activate the exterior microphone to a “listening” state. Thus, when a matching key fob approaches the vehicle and is authenticated, the vehicle bus wakes up and the rest of the microphone system is “listening” for voice commands. Processing of voice command words may be achieved within the IVI system with a voice processing algorithm. When a voice command is received and recognized, the IVI system may transmit message(s) on the vehicle bus to execute useful functions. These include messages to open/close the lift gate, lock/unlock doors, open the side door, close the side door, etc.

The invention comprises, in one form thereof, a motor vehicle including a microphone detecting sounds originating outside of the motor vehicle. The microphone is disposed within a housing. A camera captures images of a scene outside of the motor vehicle. The camera is also disposed within the housing.

The invention comprises, in another form thereof, a method of operating an infotainment system in a motor vehicle, including providing a housing within the motor vehicle. A microphone and a camera are installed inside the housing. Sounds originating outside of the motor vehicle are detected by use of the microphone. Images of a scene outside of the motor vehicle are captured by use of the camera. Signals dependent upon the detected sounds are transmitted to the infotainment system. Signals dependent upon the captured images are transmitted to the infotainment system.

The invention comprises, in yet another form thereof, a motor vehicle including a microphone detecting sounds originating outside of the motor vehicle. The microphone is disposed within a housing. A camera captures images of a scene outside of the motor vehicle. The camera is disposed within the housing. A communication line is disposed outside the housing and carries both signals that are dependent upon the sounds detected by the microphone and signals that are dependent upon the images captured by the camera.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a block diagram of one embodiment of an exterior microphone camera system of the present invention.

FIG. 2 is a flow chart of one embodiment of a method of the present invention for operating an infotainment system in a motor vehicle.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

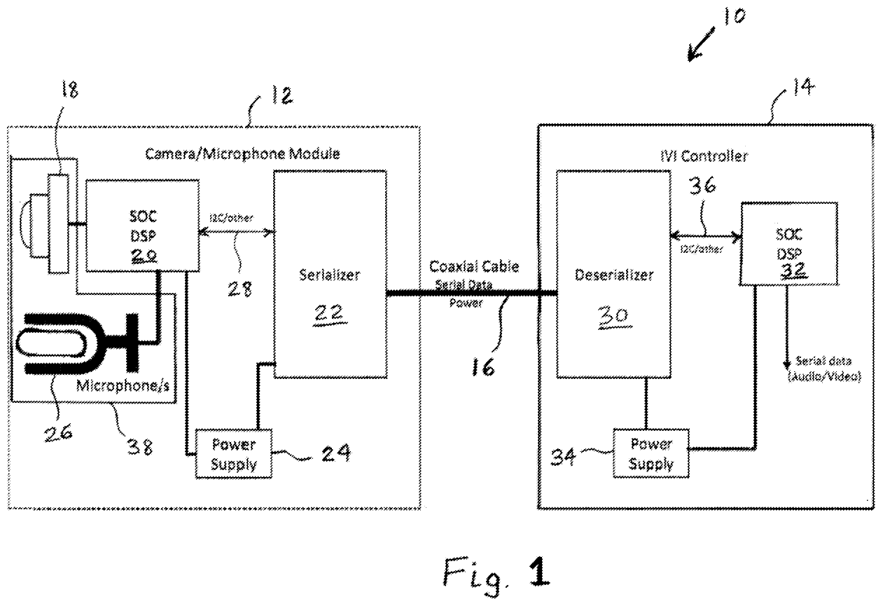

FIG. 1 illustrates one embodiment of an exterior microphone camera system 10 of the present invention. System 10 includes a camera/microphone module 12 and an IVI controller 14 connected together by a coaxial cable 16. Coaxial cable 16 may carry serial data and power. Camera/microphone module 12 includes an image sensor 18, which may be in the form of a camera, a system on chip (SOC) digital signal processor (DSP) 20, a serializer 22, a power supply 24, and at least one microphone 26. SOC DSP 20 and serializer 22 may be interconnected by an I²C serial communication bus 28 or other bus. IVI controller 14 includes a deserializer 30, SOC DSP 32, and a power supply 34. SOC DSP 32 and deserializer 30 may be interconnected by an I²C serial communication bus 36 or other bus.

Image sensor 18 and microphone 26 may be disposed in a common housing 38. In another embodiment, DSP 20, I²C serial communication bus 28, serializer 22 and/or power supply 24 may also be disposed in the housing. It is possible for no other components, other than those listed above in this paragraph, to be disposed in the housing.

During use, microphone 26 receives sound from outside the motor vehicle in which camera system 10 is disposed. In response to detecting the sound, microphone 26 transmits microphone signals to serializer 22, wherein the signals are indicative of the sounds that microphone 26 detects.

Coaxial cable 16 may transmit video signals from camera 18 to in-vehicle infotainment (IVI) controller 14. Coaxial cable 16 may also be used to transmit audio signals from microphone 26 to IVI controller 14. Coaxial cable 16 may accommodate bi-directional control signals to and from Camera/Microphone module 12 and IVI controller 14.

When IVI controller 14 wakes up, IVI controller 14 may cause microphone 26 to enter a “listening” state. Thus, when a matching key fob approaches the vehicle and is authenticated, the vehicle bus wakes up and microphone 26 begins “listening” for voice commands. Processing of voice command words may be performed within IVI controller 14 by a voice processing algorithm. When a voice command is received and recognized, the IVI controller 14 may transmit message(s) on the vehicle bus to execute useful functions. These include messages to open/close the lift gate, lock/unlock doors, open the side door, close the side door, etc.

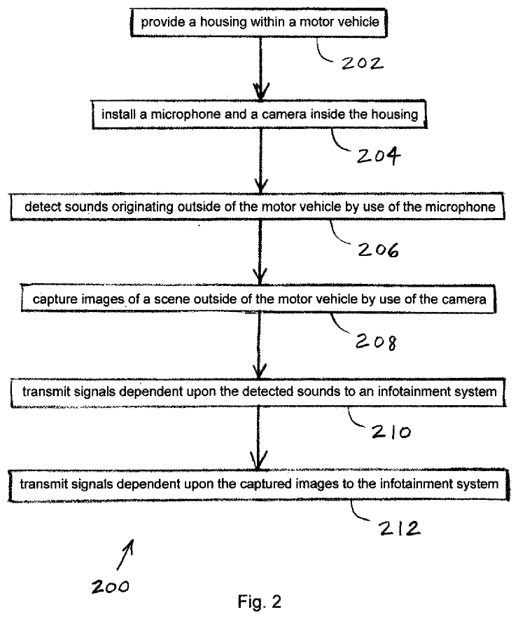

FIG. 2 illustrates one embodiment of a method 200 of the present invention for operating an infotainment system in a motor vehicle. In a first step 202, a housing is provided within the motor vehicle. For example, housing 38 may be provided within a motor vehicle.

Next, in step 204, a microphone and a camera are installed inside the housing. For example, microphone 26 and camera 18 may be installed inside housing 38.

In a next step 206, sounds originating outside of the motor vehicle are detected by use of the microphone. For example, microphone 26 may sense sounds originating outside of the motor vehicle

In step 208, images of a scene outside of the motor vehicle are captured by use of the camera. For example, camera 18 may capture images of a scene outside of the motor vehicle.

In a next step 210, signals dependent upon the detected sounds are transmitted to the infotainment system. For example, microphone 26 may transmit microphone signals to serializer 22, wherein the signals are indicative of the sounds that microphone 26 detects. Coaxial cable 16 may also be used to transmit audio signals, such as the microphone signals, from microphone 26 to IVI controller 14.

In a final step 212, signals dependent upon the captured images are transmitted to the infotainment system. For example, coaxial cable 16 may transmit video signals from camera 18 to in-vehicle infotainment (IVI) controller 14.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A motor vehicle, comprising:
a housing;
a microphone configured to detect sounds originating outside of the motor vehicle, the microphone being disposed within the housing; and
a camera configured to capture images of a scene outside of the motor vehicle, the camera being disposed within the housing.

2. The motor vehicle of claim 1 wherein the housing has a volume of less than one cubic foot.

3. The motor vehicle of claim 1 wherein no other components are disposed within the housing.

4. The motor vehicle of claim 1 further comprising a communication line configured to carry both signals that are dependent upon the sounds detected by the microphone and signals that are dependent upon the images captured by the camera.

5. The motor vehicle of claim 4 further comprising an in-vehicle infotainment controller electrically connected to the communication line and configured to receive both the signals that are dependent upon the sounds detected by the microphone and the signals that are dependent upon the images captured by the camera.

6. The motor vehicle of claim 1 further comprising a digital signal processor electrically connected to both the microphone and the camera, the digital signal processor being disposed in the housing.

7. The motor vehicle of claim 6 further comprising a serializer electrically connected to the digital signal processor, the serializer being disposed in the housing.

8. A method of operating an infotainment system in a motor vehicle, the method comprising:
providing a housing within the motor vehicle;
installing a microphone and a camera inside the housing;
detecting sounds originating outside of the motor vehicle by use of the microphone;
capturing images of a scene outside of the motor vehicle by use of the camera;
transmitting signals dependent upon the detected sounds to the infotainment system; and
transmitting signals dependent upon the captured images to the infotainment system.

9. The method of claim 8 wherein the wherein the housing has a volume of less than one-half cubic foot.

10. The method of claim 8 wherein no other components are disposed within the housing.

11. The method of claim 8 further comprising using a communication line to carry both signals that are dependent upon the sounds detected by the microphone and signals that are dependent upon the images captured by the camera.

12. The method of claim 11 further comprising:
electrically connecting an in-vehicle infotainment controller to the communication line; and
using the in-vehicle infotainment controller to receive both the signals that are dependent upon the sounds detected by the microphone and the signals that are dependent upon the images captured by the camera.

13. The method of claim 8 further comprising installing a digital signal processor in the housing such that the digital signal processor is electrically connected to both the microphone and the camera.

14. The method of claim 13 further comprising installing a serializer in the housing such that the serializer is electrically connected to the digital signal processor.

15. A motor vehicle, comprising:
a housing;
a microphone configured to detect sounds originating outside of the motor vehicle, the microphone being disposed within the housing;
a camera configured to capture images of a scene outside of the motor vehicle, the camera being disposed within the housing; and
a communication line disposed outside the housing and configured to carry both signals that are dependent upon the sounds detected by the microphone and signals that are dependent upon the images captured by the camera.

16. The motor vehicle of claim 15 wherein the housing has a volume of less than one-quarter cubic foot.

17. The motor vehicle of claim 15 wherein no other components are disposed within the housing.

18. The motor vehicle of claim 15 further comprising an in-vehicle infotainment controller electrically connected to the communication line and configured to receive both the signals that are dependent upon the sounds detected by the microphone and the signals that are dependent upon the images captured by the camera.

19. The motor vehicle of claim 15 further comprising a digital signal processor electrically connected to both the microphone and the camera, the digital signal processor being disposed in the housing.

20. The motor vehicle of claim 19 further comprising a serializer electrically connected to the digital signal processor, the serializer being disposed in the housing.
